(19) United States
(12) Patent Application Publication
(10) Pub. No.: US 2008/0175628 A1
(43) Pub. Date: Jul. 24, 2008

(54) POWDER FILLING METHOD, POWDER CONTAINER, DEVELOPER REPLENISHING DEVICE, DEVELOPER REPLENISHING METHOD, AND IMAGE FORMING APPARATUS

(76) Inventors: Emi Kita, Tokyo (JP); Junichi Terai, Kanagawa (JP); Yuki Oshikawa, Kanagawa (JP); Hiroyuki Okaji, Kanagawa (JP); Mugijirou Uno, Kanagawa (JP); Keiko Matsumoto, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/971,580

(22) Filed: Jan. 9, 2008

(30) Foreign Application Priority Data
Jan. 23, 2007 (JP) 2007-013076

(51) Int. Cl. G03G 15/08

(52) U.S. Cl. 399/262

(57) ABSTRACT

A powder filling method, which fills at least two kinds of powders with different specific gravities into a powder container, and by which a region having only a powder with the highest specific gravity out of the at least two kinds of powders is prevented from being generated in the filled powder container. A toner, which is a first powder that does not include a carrier having the highest specific gravity, is mixed with air in a toner storage portion. The air is introduced into the toner particles to increase the bulk of the toner, and then a toner filling device fills a toner bottle serving as the powder container with the toner having the air. Upon completion of such filling, a carrier filling device starts filling the carrier, which is a second powder, into the toner bottle. Filling of the carrier is completed before the air is released from the toner particles contained in the toner bottle and thereby the bulk of the toner is reduced and then stabilized.

### BACKGROUND OF THE INVENTION

1. Field of the Invention

The present invention relates to a powder filling method for filling at least two kinds of powders with different specific gravities into a powder container, a powder container that is filled with the powders by the powder filling method, a developer replenishing device having the powder container, and an image forming apparatus. Moreover, the present invention relates to a developer replenishing method using the powder container, and a method for manufacturing a powder-filled powder container.

2. Description of the Related Art

As the powder container for containing powders, there is a powder container that has a powder containing portion the volume of which decreases and a powder discharge port and that discharges powders to the outside by means of negative pressure acting on the powders. Such a powder container is used in various technical fields. In the field of image forming apparatuses, for example, a powder container disclosed in Japanese Published Unexamined Patent Application No. 2004-323062 (referred to as “Prior Art 1” hereinafter) is known.

In such a powder container, a toner to be replenished into a developing device is contained as powder in a powder containing portion. This powder containing portion is formed of a pouch-like deformable elastic material. A developer supply device of the image forming apparatus described in Prior Art 1 has a conveyance path member in which the toner travels and a powder pump, wherein the toner located in the vicinity of a powder discharge port is discharged from the powder discharge port by negative pressure obtained from the suction force of the powder pump, and is then replenished into the developing device. At this moment, the powder containing portion is caused to contract by the negative pressure obtained from the suction force of the powder pump, whereby the volume of the powder container decreases. Moreover, when the toner located in the vicinity of the powder discharge port is discharged by the negative pressure toward the developing device, the toner that is not located in the vicinity of the powder discharge port moves toward the powder discharge port because the toner located in the vicinity of the powder discharge port is discharged to the outside. In such a powder container, because suction of the powder pump discharges the toner and moves the toner within the powder containing portion, a powder conveying member for moving the toner into the powder containing portion is not required.

Also, the powder container provided in the image forming apparatus described in Japanese Published Unexamined Patent Application No. 2004-264510 (referred to as “Prior Art 2” hereinafter) contains a developer that has a toner and a carrier in a predetermined proportion. By containing the developer in the powder container and supplying both the toner and carrier to the developing device, a toner to be consumed can be replenished and a carrier within the developing device can be replaced. By replacing the carrier, the proportion of a degraded carrier in the carrier existing in the developing device can be lowered.

A powder container that contains two kinds of powders with different specific gravities, such as the toner and the carrier contained in the powder container described in Prior Art 2, is used not only in an image forming apparatus but also in various technical fields.

Generally, in a powder container that contains two kinds of powders with different specific gravities, it is desired that the powders be mixed uniformly within the powder container after the powders are filled therein. For example, in a powder container that contains a developer comprising a toner and a carrier as two kinds of powders, it is desired that the toner and the carrier be mixed uniformly when supplying the contained developer to a developing device. This is because if the toner and the carrier are mixed uniformly, the proportions of the toner and the carrier within the developer to be supplied to the developing device can be kept constant. However, even if the two kinds of powders with different specific gravities are uniformly mixed at once, the powder with a high specific gravity tends to move below the powder with a low specific gravity, while the air contained in particles of the powders is released by a stirring operation performed when mixing the powders. For this reason, if the air between the particles is released after the stirring operation, the powder with a high specific gravity exists on the lower side, while the powder with a low specific gravity exists on the upper side, which is unbalanced. Therefore, it is technically difficult to obtain the situation where the two kinds of powders with different specific gravities are uniformly mixed, and thus in the powder container that contains these powders, the powders exist therein are in an unbalanced state.

Problems sometimes occur if a region having only the powder with the highest specific gravity is generated in such an unbalanced state.

As one example of such problems, there will be described a problem that is caused when a powder container for containing a developer comprising a toner and a carrier as two kinds of powders with different specific gravities has a region having only the carrier as the powder with the highest specific gravity.

In the image forming apparatus of Prior Art 1 described above, the powder container contains a toner, and the developer supply device having the powder pump is used to replenish the toner to the developing device. As a result of earnest studies, the six inventors of the present invention have discovered that, as with the powder container described in Prior Art 2, the developer comprising a toner and a carrier could be contained in the powder container of the image forming apparatus described in Prior Art 1, and the developer could be supplied to the developing device by means of negative pressure of the powder pump.

Also, as a result of experiments performed using the configuration in which the developer is supplied to the developing device by means of the negative pressure of the powder pump, the inventors have discovered a problem as follows. Specifically, as long as the developer is constituted by a toner and a carrier, the powder pump could convey such developer by means of the negative pressure, but the problem is that conveyance of the carrier only that is performed by the powder pump was stopped. When the carrier conveyance performed by the powder pump was stopped, the carrier was accumulated in the middle of the conveyance path member, and consequently the carrier did not move even when the negative pressure was applied thereto.

The following cases can be considered as a situation in which the developer, which is contained in the powder container of the image forming apparatus of Prior Art 1, is conveyed by the negative pressure of the powder pump, and then only the carrier of the developer is conveyed when supplying the developer to the developing device.

In the first case, when filling the powder container with the toner and carrier, the toner is filled into the powder container, and then, in a state in which the bulk of the toner within the powder container is stable, the carrier is filled into the powder container. When the toner bulk is stable, that is, when air between toner particles is released so that friction occurs easily between the particles, the carrier cannot penetrate between the toner particles even if the carrier with a high specific gravity is replenished after filling the toner into the powder container. At this moment, the toner exists on the lower side of a powder containing portion, while the carrier exists on the upper side of the powder containing portion. Here, an opening portion through which the developer is filled into the powder containing portion is the powder discharge port. By turning the powder discharge port upward when filling the developer into the powder containing portion, the toner is placed on a far side (lower side) of the powder containing portion and the carrier is placed in the vicinity of the powder discharge port (upper side). When such a powder container is installed in the image forming apparatus to convey the developer by using the negative pressure of the powder pump, the carrier exists in the vicinity of the powder discharge port at the time of installation. Among the regions that mostly have the carrier, a region having only the carrier might be generated. At this moment, the region having only the carrier reaches the vicinity of the powder discharge port, and only the carrier is conveyed when a developer conveyance operation is performed, which might disable the powder pump to convey the developer.

In the second case, when filling the powder container with the toner and carrier, the toner is filled into the powder container after the carrier is filled into the powder container. When the toner is supplied to the powder container filled with the carrier, an aggregate of the toner is stacked on an aggregate of the carrier. Here, an opening portion through which the developer is filled into the powder containing portion is the powder discharge port. By turning the powder discharge port upward when filling the developer into the powder containing portion, the toner is placed in the vicinity of the powder discharge port of the powder containing portion (upper side) and the carrier is placed on the far side (lower side). Among the regions that mostly have the carrier, a region having only the carrier might be generated. When such a powder container is installed in the image forming apparatus to convey the developer by using the negative pressure of the powder pump, the developer having a large proportion of toner is conveyed to the vicinity of the powder discharge port at the time of installation, and thus there is no problem in developer conveyance performed by the powder pump. However, if the amount of developer within the powder containing portion decreases, only the carrier might remain in the powder containing portion. When this carrier is conveyed using the powder pump, the powder pump might no longer be able to convey the developer.

The above has described examples of problems occurring in the powder container used in the image forming apparatus, the powder container containing a developer comprising toner particles and carrier particles, which are powders with different specific gravities. However, the one containing two kinds of powders with different specific gravities is not limited to the powder container used in the image forming apparatus. Moreover, the problem in which the powder container has a region having only the powder with the highest specific gravity is not limited to the powder container used in the image forming apparatus. Also, the above has described the powder container that contains two kinds of powders with different specific gravies, but the number of types of powders with different specific gravities is not limited to two, and thus, even if there are three or more types of powders, the same problem might occur in which a region having only the powder with the highest specific gravity is generated within the powder container.

### SUMMARY OF THE INVENTION

The present invention was contrived in view of the above problems, and it is an object of the present invention to provide a powder filling method for filling at least two kinds of powders with different specific gravities into a powder container and capable of preventing the filled powder container from being provided with a region in which exists only the powder with the highest specific gravity, out of the at least two kinds of powders, a powder-filled powder container that is filled with the powders by the powder filling method, a developer replenishing device that uses the powder-filled powder container, a developer replenishing method, an image forming apparatus, and a method for manufacturing the powder-filled powder container.

In an aspect of the present invention, a powder filling method fills at least two kinds of powders with different specific gravities into a powder container. The method comprises the steps of: mixing air with a first powder of the at least two kinds of powders, which comprises at least one powder that does not include a powder with the highest specific gravity, and then introducing the air into particles of the first powder to increase the bulk of the first powder; starting to fill a second powder of the at least two kinds of powders, which includes a powder with the highest specific gravity, into the powder container after starting to fill the first powder into the powder container; and completing filling of the second powder before the air is released from the particles of the first powder within the powder container and thereby the bulk of the first powder is reduced and then stabilized.

In another aspect of the present invention, a powder-filled powder container is obtained by filling a powder container with at least two kinds of powders with different specific gravities. The at least two kinds of powders are filled into the powder container by means of a powder filling method having the steps of: mixing air with a first powder of the at least two kinds of powders, which comprises at least one powder that does not include a powder with the highest specific gravity, and then introducing the air into particles of the first powder to increase the bulk of the first powder; starting to fill a second powder of the at least two kinds of powders, which includes a powder with the highest specific gravity, into the powder container after starting to fill the first powder into the powder container; and completing filling of the second powder before the air is released from the particles of the first powder within the powder container and thereby the bulk of the first powder is reduced and then stabilized.

In another aspect of the present invention, a developer replenishing device comprises a developer container that contains a developer comprising a toner and a carrier; and a developer conveying device for conveying the developer to a destination of conveyance. The developer container is a powder-filled powder container, which is obtained by filling a powder container with at least two kinds of powders with different specific gravities, the at least two kinds of powders being filled into the powder container by means of a powder filling method having the steps of mixing air with a first powder of the at least two kinds of powders, which comprises at least one powder that does not include a powder with the highest specific gravity, and then introducing the air into particles of the first powder to increase the bulk of the first powder; starting to fill a second powder of the at least two kinds of powders, which includes a powder with the highest specific gravity, into the powder container after starting to fill the first powder into the powder container; and completing filling of the second powder before the air is released from the particles of the first powder within the powder container and thereby the bulk of the first powder is reduced and then stabilized.

In another aspect of the present invention, an image forming apparatus comprises a latent image carrier; a developing device that develops a latent image formed on the latent image carrier using a developer contained in a developer containing portion; and a developer replenishing device for supplying the developer to the developer containing portion. The developer replenishing device is a developer replenishing device having a developer container that contains a developer comprising a toner and a carrier; and a developer conveying device for conveying the developer to a destination of conveyance. The developer container is a powder-filled powder container, which is obtained by filling a powder container with at least two kinds of powders with different specific gravities, the at least two kinds of powders being filled into the powder container by means of a powder filling method having the steps of mixing air with a first powder of the at least two kinds of powders, which comprises at least one powder that does not include a powder with the highest specific gravity, and then introducing the air into particles of the first powder to increase the bulk of the first powder; starting to fill a second powder of the at least two kinds of powders, which includes a powder with the highest specific gravity, into the powder container after starting to fill the first powder into the powder container; and completing filling of the second powder before the air is released from the particles of the first powder within the powder container and thereby the bulk of the first powder is reduced and then stabilized.

In another aspect of the present invention, a developer replenishing method for replenishing a developer comprising a toner and a carrier having different specific gravities, from a developer container to a developing device. The method comprising the steps of mixing air with the toner and then introducing the air into particles of the toner to increase the bulk of the toner; starting to fill the carrier into the developer container after starting to fill the toner into the developer container; completing filling of the carrier before the air is released from the particles of the toner within the developer container and thereby the bulk of the toner is reduced and then stabilized; and discharging the developer from the developer container filled with the developer comprising the toner and the carrier, to replenish the developer into the developing device.

In another aspect of the present invention, a powder-filled powder container manufacturing method for manufacturing a powder container filled with at least two kinds of powders with different specific gravities. The method comprising the steps of mixing air with a first powder of the at least two kinds of powders, which comprises at least one powder that does not include a powder with the highest specific gravity, and then introducing the air into particles of the first powder to increase the bulk of the first powder; starting to fill a second powder of the at least two kinds of powders, which includes a powder with the highest specific gravity, into the powder container after starting to fill the first powder into the powder container; and completing filling of the second powder before the air is released from the particles of the first powder within the powder container and thereby the bulk of the first powder is reduced and then stabilized.

### BRIEF DESCRIPTION OF THE DRAWINGS

The above and other objects, features and advantages of the present invention will become more apparent from the following detailed description taken with the accompanying drawings in which:

FIG. 1 is a view showing a schematic configuration of a copying machine according to an embodiment of the present invention;

FIG. 2 is a view showing a schematic configuration of a developing device and photoreceptors of the copying machine;

FIG. 3 is a schematic diagram showing a flow of a developer within the developing device;

FIG. 4 is a perspective view showing the exterior of the developing device;

FIG. 5 is a perspective view showing a configuration of a toner replenishing device according to the present embodiment;

FIG. 6 is a cross-sectional view showing a configuration of the toner replenishing device;

FIG. 7 is a perspective view showing the exterior of a toner bottle according to the present embodiment;

FIG. 8 is a view showing a configuration of a powder filling device according to the present embodiment;

FIGS. 9A through 9D are diagrams for explaining a powder filling method of Example 1 according to the present embodiment; and

FIGS. 10A through 10D are diagrams for explaining the powder filling method of Example 2 according to the present embodiment.

### DESCRIPTION OF THE PREFERRED EMBODIMENTS

In the present invention, a first powder that does not include a powder with the highest specific gravity is mixed with air, and the air is introduced into particles of the first powder to increase the bulk of the first powder, whereby the fluidity of the first powder can be increased, and second powder particles can be introduced into the first powder particles when the second powder is supplied. Then, after starting to fill the first powder into a powder container, the second powder that includes the powder with the highest specific gravity is filled into the powder container, whereby a region in which exists only the second powder having the powder with the highest specific gravity can be prevented from being generated on the lower side of the powder container, with respect to a region having the first powder. Then, before the air between the first powder particles within the powder container is released and thereby the bulk of the first powder is reduced and then stabilized, that is, when the fluidity of the first powder is high, filling of the second powder is completed, and consequently the second powder that includes the powder having higher specific gravity than the first powder can be introduced into the first powder particles. Therefore, a region in which exists only the second powder having the powder with the highest specific gravity can be prevented from being generated on the upper side of the powder container, with respect to the region having the first powder. Furthermore, because the second powder is introduced into the first powder particles, a large number of second powder particles hardly form an aggregate thereof and a region having only the second powder existing in the first powder can be prevented from being generated.

As an image forming apparatus to which the present invention is applied, an embodiment of a tandem color laser copying machine (simply called “copying machine” hereinafter) in which a plurality of photoreceptors are disposed in parallel with each other will be described below.

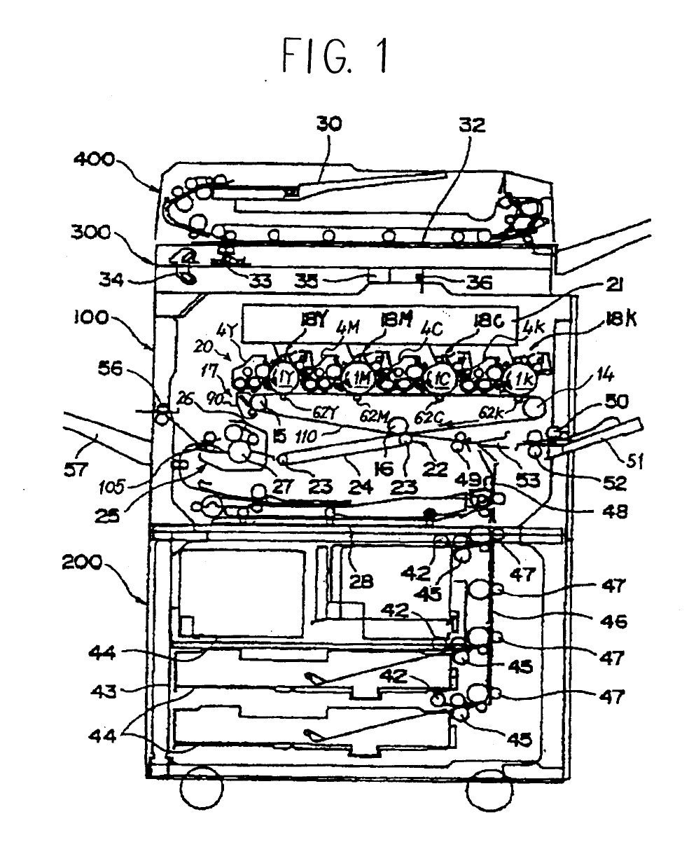

FIG. 1 shows a schematic configuration of a copying machine according to the present invention. This copying machine has a printer portion 100, a paper feeding device 200 on which the printer portion is placed, a scanner 300 placed fixedly on the printer portion 100, and the like. The copying machine also has an automatic original conveying device 400 that is placed fixedly on the scanner 300.

The printer portion 100 has an image forming unit 20 that is constituted by four process cartridges 18Y, M, C and K for forming images of colors of yellow (Y), magenta (M), cyan (C), and black (K) respectively. Y, M, C and K provided at the ends of the reference numerals indicate the members for the colors, yellow, cyan, magenta and black, respectively (same hereinafter). An optical writing unit 21, an intermediate transfer unit 17, a secondary transfer device 22, a resist roller pair 49, a belt fixing type fixing device 25, and the like are disposed besides the process cartridges 18Y, M, C and K.

The optical writing unit 21 has a light source, a polygon mirror, an f-θ lens, a reflecting mirror and the like, not shown, and emits a laser beam onto the surface of an after-described photoreceptor on the basis of image data.

Each of the process cartridges 18Y, M, C and K has a drum-like photoreceptor 1, a charging unit, a developing device 4, a drum cleaning device, a destaticizing unit, and the like.

The yellow process cartridge 18 will be described hereinafter.

The surface of a photoreceptor 1Y is uniformly charged by the charging unit functioning as charging means. The surface of the photoreceptor 1Y that is subjected to charging processing is irradiated with a laser beam that is modulated and deflected by the optical writing unit 21. Consequently, potential of the irradiated portion (exposed portion) is attenuated. Due to this attenuation, a Y electrostatic latent image is formed on the surface of the photoreceptor 1Y. The formed Y electrostatic latent image is developed by a developing device 4Y serving as developing means, whereby a Y toner image is obtained.

The Y toner image formed on the Y photoreceptor 1Y is primarily transferred to an intermediate transfer belt 110 described hereinafter. Transfer residual toner on the surface of the photoreceptor 1Y is cleaned by the drum cleaning device after the Y toner image is primarily transferred.

In the Y process cartridge 18Y, the photoreceptor 1Y cleaned by the drum cleaning device is destaticized by the destaticizing unit. Then, the photoreceptor 1Y is uniformly charged by the charging unit and thereby returns to the initial state. The series of processes described above is same for the other process cartridges 18M, C and K.

The intermediate transfer unit will be described next.

The intermediate transfer unit 17 has the intermediate transfer belt 110, a belt cleaning device 90 and the like. The intermediate transfer unit 17 further has a stretching roller 14, a drive roller 15, a secondary transfer backup roller 16, four primary transfer bias rollers 62Y, M, C and K, and the like.

The intermediate transfer belt 110 is tension-stretched by a plurality of rollers including the stretching roller 14. The intermediate transfer belt 110 is then moved endlessly in a clockwise direction in the drawing by rotation of the drive roller 15 that is driven by a belt drive motor, not shown.

Each of the four primary transfer bias rollers 62Y, M, C and K is disposed in contact with the inner peripheral surface of the intermediate transfer belt 110, and is applied with a primary transfer bias from a power source, not shown. Furthermore, the inner peripheral surface of the intermediate transfer belt 110 is pressed against the photoreceptors 1Y, M, C and K to form primary transfer nips. At each of the primary transfer nips, a primary transfer electric field is formed between each photoreceptor 1 and each primary transfer bias roller 62 due to the influence of the primary transfer bias.

The abovementioned Y toner image formed on the Y photoreceptor 1Y is primarily transferred onto the intermediate transfer belt 110 due to the influence of the primary transfer electric field or nip pressure. M, C and K toner images formed on the M, C and K photoreceptors 1M, C and K are sequentially superimposed and primarily transferred onto the Y toner image. A four-color superimposed toner image (called “four-color toner image” hereinafter), i.e., the multiple toner image, is formed on the intermediate transfer belt 110 due to the primary transfer performed by superimposing the toner images.

The four-color toner image that is transferred onto the intermediate transfer belt 110 is secondarily transferred onto a transfer sheet, i.e., a recording medium that is not shown, by a secondary transfer nip described hereinafter. The residual transfer toner that remains on the surface of the intermediate transfer belt 110 after it passes through the secondary transfer nip is cleaned by the belt cleaning device 90 that holds the belt between this belt cleaning device and the drive roller 15 located on the left side of the drawing.

Next, the secondary transfer device 22 will be described.

The secondary transfer device 22 that stretches a sheet conveying belt 24 by means of two stretching rollers 23 is disposed on the lower side of the intermediate transfer unit 17 as shown. The sheet conveying belt 24 is endlessly moved in a counterclockwise direction in the drawing as at least either one of the stretching rollers 23 is driven and rotated. Of the two stretching rollers 23, the stretching roller 23 disposed on the right side in the drawing holds the intermediate transfer belt 110 and the sheet conveying belt 24 between the stretching roller 23 and the secondary backup roller 16 of the intermediate transfer unit 17. Accordingly, the secondary transfer nip where the intermediate transfer belt 110 of the intermediate transfer unit 17 comes into contact with the sheet conveying belt 24 of the secondary transfer device 22 is formed. Then, this stretching roller 23 is applied with a secondary transfer bias having a polarity opposite to the polarity of the toner, by the unshown power source. Due to this application of the secondary transfer bias, a secondary transfer electric field that electrostatically moves the four-color toner image formed on the intermediate transfer belt 110 of the intermediate transfer unit 17 from the belt side toward this stretching roller 23 is formed at the secondary transfer nip. The four-color toner image that is affected by the secondary transfer electric field or nip pressure is secondarily transferred onto the transfer sheet which is sent to the secondary transfer nip by the after-described resist roller pair 49 in synchronization with the four-color toner image formed on the intermediate transfer belt 110. It should be noted that a charger for charging the transfer sheet in a noncontact manner may be provided in place of the secondary transfer system that applies a secondary transfer bias to this stretching roller 23.

In the paper feeding device 200 provided in a lower section of the copying machine main body, a plurality of paper feeding cassettes 44, each of which can contain a plurality of stacked transfer sheets, are disposed vertically in a stacked manner. Each of the paper feeding cassettes 44 presses the top transfer sheet of the stacked transfer sheets against a paper feeding roller 42. Then, by rotating the paper feeding roller 42, the top transfer sheet is sent out toward a paper feeding path 46.

The paper feeding path 46 that receives the transfer sheet sent out from the paper feeding cassette 44 has a plurality of conveying roller pairs 47 and the resist roller pair 49 that is provided in the vicinity of an end of the paper feeding path. The paper feeding path 46 conveys the transfer sheet toward the resist roller pair 49. The transfer sheet conveyed toward the resist roller pair 49 is sandwiched between the roller portions of the resist roller pair 49. On the other hand, in the intermediate transfer unit 17, the four-color toner image formed on the intermediate transfer belt 110 enters the secondary transfer nip as the belt endlessly moves. The resist roller pair 49 sends the transfer sheet sandwiched between the roller portions at timing at which the transfer sheet is attached to the four-color toner image at the secondary transfer nip. In this manner, the four-color toner image formed on the intermediate transfer belt 110 is attached to the transfer sheet at the secondary transfer nip. Then, the four-color toner image is secondarily transferred onto the transfer sheet and thereby becomes a full-color image on the white transfer sheet. The transfer sheet on which the full-color image is formed in this manner leaves the secondary transfer nip as the sheet conveying belt 24 endlessly moves, and is then sent from the top of the sheet conveying belt 24 to the fixing device 25.

The fixing device 25 has a belt unit that is caused to move endlessly while stretching a fixing belt 26 by means of two rollers, and a pressure roller 27 that is pressed against one of the rollers of the belt unit. The fixing belt 26 and the pressure roller 27 abut against each other to form a fixing nip, and the transfer sheet received from the sheet conveying belt 24 is sandwiched by this nip. Of the two rollers of the belt unit, the roller that is pressed by the pressure roller 27 has a heat source therein, not shown, and applies pressure on the fixing belt 26 by using heat generated by the heat source. The fixing belt 26 applied with pressure then heats the transfer sheet sandwiched by the fixing nip. Due to the application of heat or the nip pressure, the full-color image is fixed onto the transfer sheet.

The transfer sheet that is subjected to fixing processing in the fixing device 25 is either stacked on a stack portion 57 provided outside of a plate of a printer casing on the left side of the drawing, or is returned to the abovementioned secondary transfer nip in order to form a toner image on the other side of the transfer sheet.

When making a copy of an original, not shown, for example, a stack of sheets of originals is set on an original platen 30 of the automatic original conveying device 400. However, if this original is a one-filing original closed by the subject document, the stack of sheets of originals is set on a contact glass 32. Prior to this setting operation, the automatic original conveying device 400 is opened with respect to the copying machine main body, and thereby the contact glass 32 of the scanner 300 is exposed. Thereafter, the one-filing original is pressed by the closed automatic original conveying device 400.

After the original is set in this manner, an unshown copy start switch is pressed, whereby original reading operation is performed by the scanner 300. However, if a sheet of original is set on the automatic original conveying device 400, the automatic original conveying device 400 automatically moves the sheet of original to the contact glass 32 before the original reading operation is performed. When the original reading operation is performed, a first traveling body 33 and a second traveling body 34 start traveling together first, and light is emitted from a light source provided in the first traveling body 33. Then, the light reflected from the surface of the original is reflected by a mirror provided within the second traveling body 34, passes through an image forming lens 35, and thereafter enters a read sensor 36. The read sensor 36 constructs image information based on the reflected light.

In parallel with such original reading operation, each element within each of the process cartridges 18Y, M, C and K, the intermediate transfer unit 17, the secondary transfer device 22, and the fixing device 25 start driving. Then, the optical writing unit 21 is driven and controlled based on the image information constructed by the read sensor 36, and Y, M, C and K toner images are formed on the photoreceptors 1Y, M, C and K respectively. These toner images become a four-color toner image that is obtained by superimposing and transferring these toner images on the intermediate transfer belt 110.

Moreover, at substantially the same time as when the original reading operation is performed, a paper feeding operation is started in the paper feeding device 200. In this paper feeding operation, one of the paper feeding rollers 42 is selected and rotated, and transfer sheets are sent out from one of the paper feeding cassettes 44 that are stored in multiple stages in a paper bank 43. The sent transfer sheets are separated one by one by a separating roller 45. Each sheet enters a reversal paper feeding path 46 and is then conveyed to the secondary transfer nip by the conveying roller pairs 47. Sheets are sometimes fed from a manual tray 51 in place of the paper feeding cassettes 44. In this case, after a manual paper feeding roller 50 is selected and rotated to send out transfer sheets placed on the manual tray 51, the separation roller 52 separates the transfer sheets one by one and feeds each sheet to a manual paper feeding path 53 of the printer portion 100.

In the present copying machine, when forming other color image composed of toners of two or more colors, the intermediate transfer belt 110 is stretched such that an upper stretching surface thereof lies substantially horizontally, and all of the photoreceptors 1Y, M, C and K are brought into contact with the upper stretching surface. On the other hand, when forming a monochrome image composed of the K toner only, the intermediate transfer belt 110 is tilted downward to the left in the drawing by using an unshown mechanism, and the upper stretching surface is separated from the Y, M and C photoreceptors 1Y, M and C. Then, out of the four photoreceptors 1Y, M, C and K, only the K photoreceptor 1K is rotated in the counterclockwise direction in the drawing to form a K toner image only. At this moment, for Y, M and C, driving of the photoreceptors 1 thereof and a developing unit is stopped to prevent the photoreceptors and developer from being depleted unnecessarily.

The present copying machine has a control unit, not shown, which is configured by a CPU and the like that control the following elements within the copying machine, and an operation display portion, not shown, which is configured by a liquid crystal display, various keybuttons, and the like. An operator can select one of three one-side printing modes for forming an image on one side of a transfer sheet, by sending a command to the control unit based on the implementation of a key input operation in the operation display portion. The three one-side printing modes are a direct discharge mode, a reversal discharge mode, and a reversal decal discharge mode.

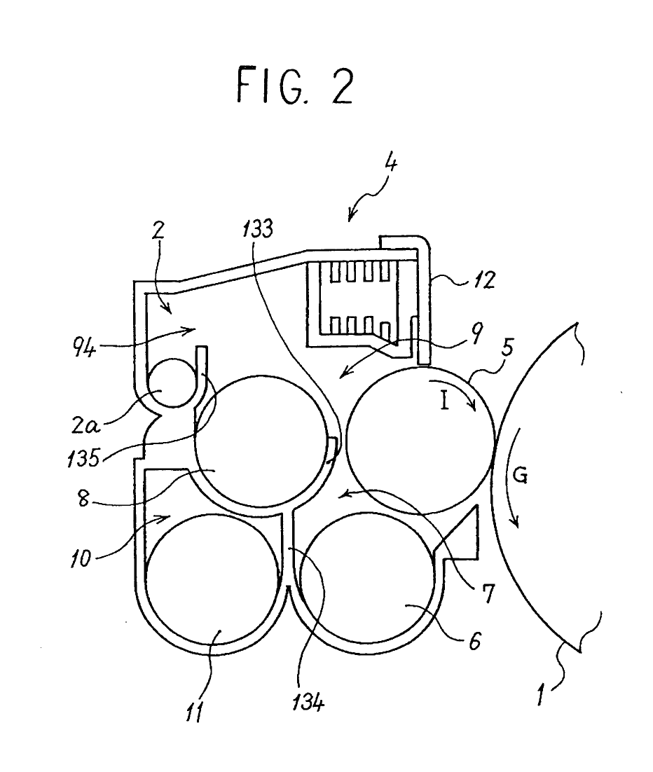

FIG. 2 shows the developing device 4 provided in one of the four process cartridges 18Y, M, C and K and the photoreceptor 1. Apart from the fact that they handle different colors, the configurations of the four process cartridges 18Y, M, C and K are essentially identical and, accordingly, the annotations Y, M, C and K to the 1411 of the drawing have been omitted.

The surface of the photoreceptor 1 is charged by the charging device, not shown, as it rotates in the direction of the arrow G in the drawing shown in FIG. 2. Toner is supplied from the developing device 4 to a latent image formed as an electrostatic latent image on the surface of the charged photoreceptor 1 by a laser beam irradiated from an exposure device, not shown, to form a toner image.

The developing device 4 has a developing roller 5 that serves as a developer carrier for supplying the toner to develop the latent image on the surface of the photoreceptor 1 while surface moving in the direction of the arrow I of the drawing. The developing device 4 also has a supply screw 8 serving as a supply conveyance member for, while supplying the developer to the developing roller 5, conveying the developer in the direction toward the rear side of FIG. 2. The supply screw 8 is a developer conveying screw that has a rotation axis and a wing portion provided on this rotation axis, and conveys the developer in the axial direction by rotating.

A development doctor 12 serving as a developer regulating member for regulating the developer supplied to the developing roller 5 to a thickness suitable for development is provided on the downstream side in the direction of surface movement of the developing roller 5 from a part facing the supply screw 8.

A recovery screw 6 serving as a recovery conveyance member for recovering the developer used for development that has passed through the developing portion and for carrying the recovered recovery developer in the same direction as the supply screw 8 is provided on the downstream side in the direction of surface movement of the developing roller 5 from the developing portion which constitutes a part facing the photoreceptor 1. A supply conveyance path 9 having the supply screw 8 is disposed in the lateral direction of the developing roller 5, and a recovery conveyance path 7 serving as a recovery conveyance path having the recovery screw 6 is disposed in parallel below the developing roller 5.

A stirring/conveyance path 10 is provided in the developing device 4 in parallel with the recovery conveyance path 7 below the supply conveyance path 9. The stirring/conveyance path 10 has a stirring screw 11 serving as a stirring/conveyance member for, while stirring the developer, conveying it in the opposite direction to the supply screw 8, the opposite direction being oriented on the front side in the drawing.

The supply conveyance path 9 and the stirring/conveyance path 10 are partitioned by a first partition wall 133 serving as a partition member. An opening portion is formed in part of the first partition wall 133 that partitions the supply conveyance path 9 and the stirring/conveyance path 10 at both ends in the front side and far side of the drawing to connect the supply conveyance path 9 and the stirring/conveyance path 10 to each other.

Note that the supply conveyance path 9 and the recovery conveyance path 7 are also partitioned by the first partition wall 133, but there is no opening portion provided in the part where the first partition wall 133 partitions the supply conveyance path 9 and the recovery conveyance path 7.

The two conveyance paths between the stirring/conveyance path 10 and the recovery conveyance path 7 are also partitioned by a second partition wall 134 serving as a partition member. An opening portion is formed in the second partition wall 134 at the front side in the drawing to connect the stirring/conveyance path 10 and the recovery conveyance path 7 to each other.

In the developing device 4, the developer containing portion for containing the developer is configured by the supply conveyance path 9, the recovery conveyance path 7, and the stirring/conveyance path 10.

The developer obtained after development is recovered by the recovery conveyance path 7, then conveyed to the front side of the cross section of FIG. 2, and shifted to the stirring/conveyance path 10 at the opening portion of the first partition wall 133 provided in a non-image region. It should be noted that a premixed toner having carrier is replenished from a toner replenishing port provided above the stirring/conveyance path 10 to the stirring/conveyance path 10, in the vicinity of the opening portion of the first partition wall 133 on the upstream side in the developer conveyance direction in the stirring/conveyance path 10.

Next, the circulation of the developer within the three developer conveyance paths will be described.

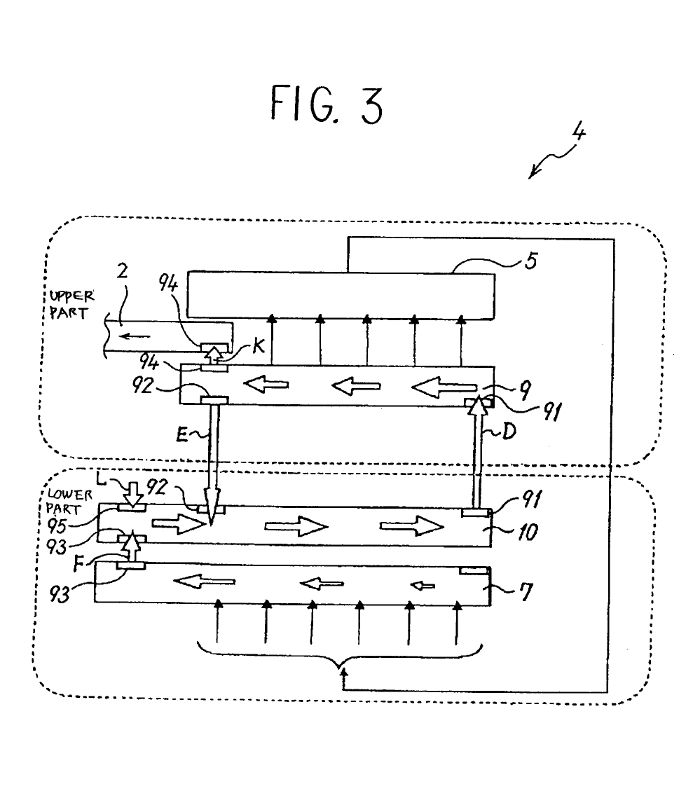

FIG. 3 shows a flow of the developer within the developer conveyance paths. The arrows in the drawing indicate the direction of movement of the developer.

In the supply conveyance path 9 to which the developer is supplied from the stirring/conveyance path 10, the developer is conveyed to the downstream side in the direction of conveyance of the supply screw 8, while the developer is being supplied to the developing roller 5. Excess developer that is supplied to the developing roller 5 and conveyed to a downstream end in the direction of conveyance of the supply conveyance path 9 without being used in development is supplied to the stirring/conveyance path 10 through an excess opening portion 92 of the first partition wall 133 (arrow E of FIG. 3).

The recovery developer that is fed from the developing roller 5 to the recovery conveyance path 7 and conveyed to the downstream end in the direction of conveyance of the recovery conveyance path 7 by the recovery screw 6 is supplied to the stirring/conveyance path 10 through a recovery opening portion 93 of the second partition member 134 (arrow F of FIG. 3).

The stirring/conveyance path 10 stirs the supplied excess developer and the recovery developer, conveys thus obtained mixture to the upstream side in the direction of conveyance of the supply screw 8, which constitutes the downstream side in the direction of conveyance of the stirring screw 11, and supplies it to the supply conveyance path 9 through a supply opening portion 91 of the first partition wall 133 (arrow D of FIG. 3).

In the stirring/conveyance path 10, the recovery developer, excess developer, and premixed toner that is replenished from a toner supply port 95 according to need are stirred and conveyed in the direction opposite to that of the developer of the recovery path 7 and the supply path 9, by the stirring screw 11. The stirred developer is transported to the upstream side in the direction of conveyance of the supply conveyance path 9 that is communicated at the downstream side in the direction of conveyance. Note that a toner density sensor, not shown, is provided below the stirring/conveyance path 10, and a toner replenishing device, which is described hereinafter in detail, is actuated by the output of the sensor so that the toner is replenished from a toner containing portion.

In the developing device 4 shown in FIG. 3 having the supply conveyance path 9 and the recovery conveyance path 7, because the developer is supplied and recovered in different developer conveyance paths, the developer used for development is prevented from being mixed in the supply conveyance path 9. Accordingly, the toner density of the developer supplied to the developing roller 5 is prevented from decreasing as the developer is sent toward the downstream side in the direction of conveyance of the supply conveyance path 9. In addition, because the apparatus has the recovery conveyance path 7 and the stirring/conveyance path 10 and the developer is recovered and supplied in different developer conveyance paths, loss of the developer used in development while it is being stirred is prevented. Accordingly, because the insufficiently stirred developer is supplied to the supply conveyance path 9, insufficient stirring of the developer to be supplied to the supply conveyance path 9 can be prevented. Because the toner density of the developer of the supply conveyance path 9 is prevented from decreasing and insufficient stirring of the developer in the supply conveyance path 9 is prevented in this manner, a constant image density can be ensured throughout development.

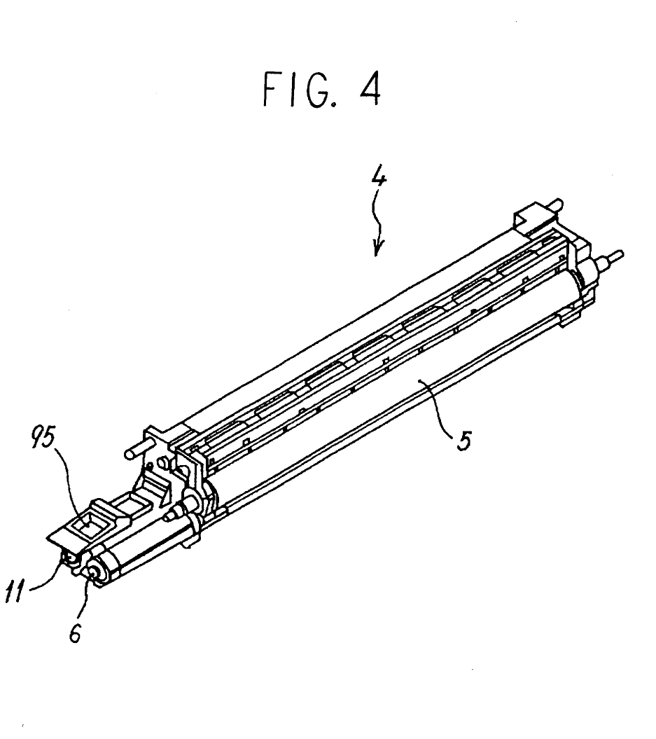

Next is described the position where the toner is replenished to the developer conveyance paths constituted by the supply conveyance path 9, the stirring/conveyance path 10 and the recovery conveyance path 7 of the developing device 4. FIG. 4 is a perspective view showing the exterior of the developing device 4.

As shown in FIG. 4, the toner replenishing port 95 for replenishing the toner is provided above an upstream end portion in the conveyance direction of the stirring/conveyance path 10 having the stirring screw 11. This toner replenishing port 95 is provided on the outer side than the end portion in the width direction of the developing roller 5.

The toner replenishing port 95 may be provided not only above the upstream end portion in the conveyance direction of the stirring/conveyance path 10, but also above a downstream end portion of the recovery conveyance path 7.

Moreover, the toner replenishing port 95 may be provided immediately above the recovery opening portion 93, which is a section where the developer is delivered and received between the recovery conveyance path 7 and the stirring/conveyance path 10. In the recovery opening portion 93 which is the delivery portion, the developer is easily mixed, and thus the developer can be stirred more efficiently by replenishing the toner at this position.

Next, a toner replenishing device 500 serving as a developer replenishing device for replenishing the premixed toner from the toner replenishing port 95 of the developing device 4 into the developing device 4 will be described.

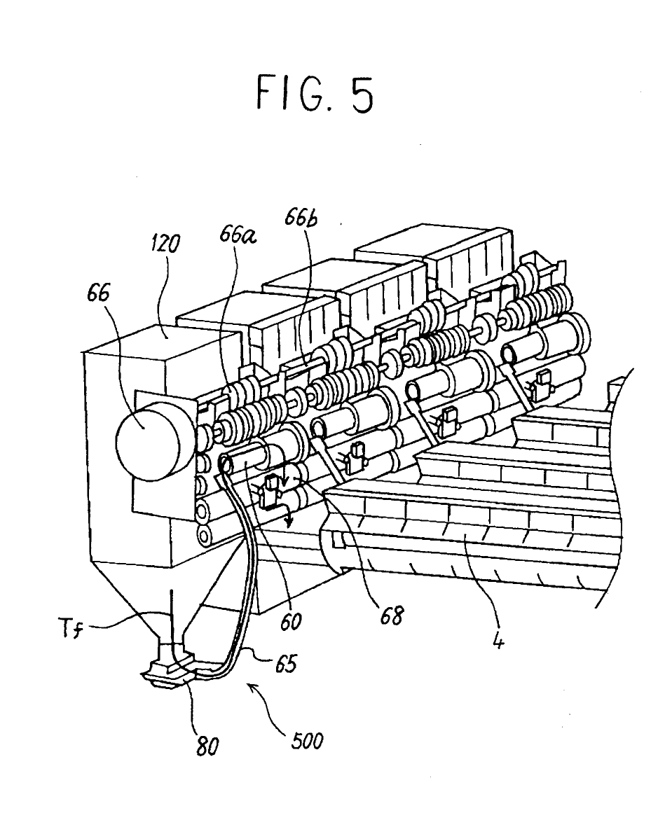

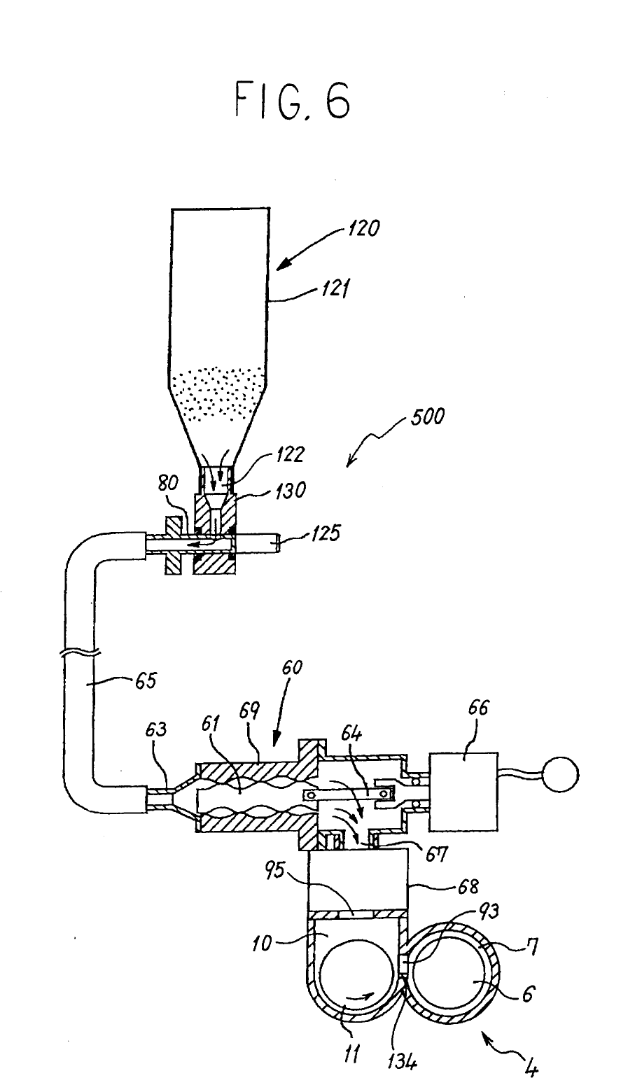

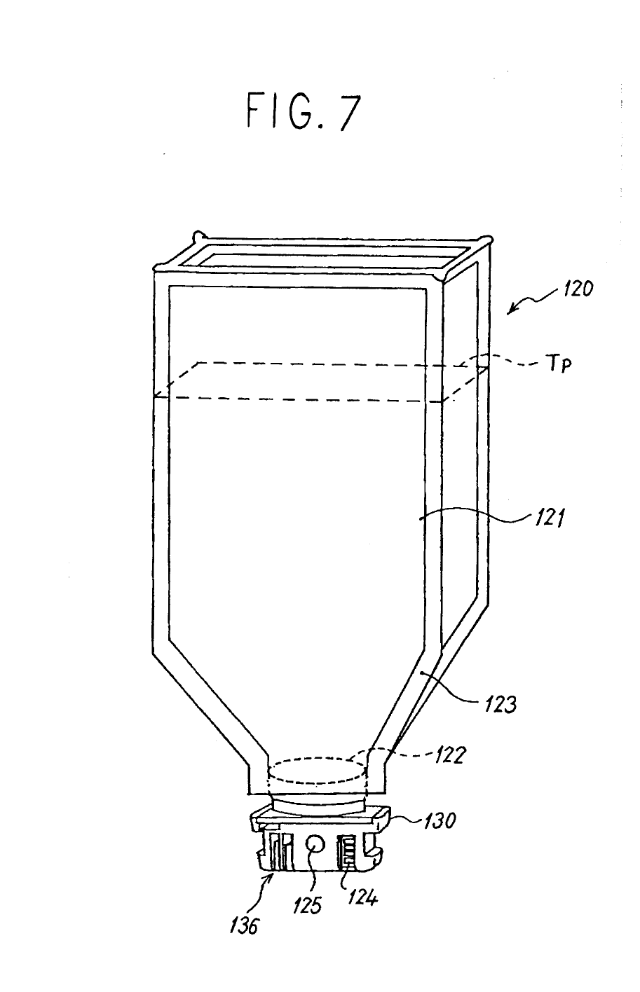

FIG. 5 shows a configuration of the toner replenishing device 500 provided in the present copying machine, and FIG. 6 shows the toner replenishing device 500. Also, FIG. 7 shows the exterior of a toner bottle 120 serving as the powder container. The toner bottle 120 is a developer container that serves as a powder container containing the premixed toner, which is a developer that has a toner and a carrier as at least two kinds of powders and has larger proportion of toner than the developer of the developing device 4. Note that reference numeral Tf shown in FIG. 5 indicates a flow of the premixed toner.

The present copying machine, which is a tandem type image forming apparatus, has a configuration in which the toner bottles 120 containing premixed toners of various colors are arranged as shown in FIG. 5. Each of the toner bottles 120 of the respective colors is connected to a replenishing unit via a toner replenishing tube 65 serving as a member for conveying each developer, the replenishing unit having a sub hopper 68, a toner pump 60 serving as the powder pump, and the like. The developing device 4 is connected to the lower side of the replenishing unit. As the toner pump 60, a mohno pump, which is a screw pump having a stator 69 made from an elastic member having a spiral groove therein, and a rotor 61 rotating within the stator 69 and thereby moving the premixed toner in the axial direction, is used. The one described in Japanese Published Unexamined Patent Application No. 2000-98721 can be used as the toner pump 60.

As shown in FIG. 6 and FIG. 7, each of the toner bottles 120 is configured by a toner containing body 121 serving as the powder containing portion, and a base member 130 that is attached to a toner discharge port 122 serving as the only powder discharge port. The specific configuration of this toner bottle 120 is described hereinafter in detail.

In a state in which the toner bottle 120 is set to the copying machine main body, a leading end of a nozzle 80 serving as a connecting member on the apparatus main body side, which is connected to the base member 130, is inserted into the toner bottle 120. Accordingly, the toner discharge port 122 and a toner receiving port of the nozzle 80 are communicated with each other. The nozzle 80 has a joint shape portion for connection of a tube, the toner replenishing tube 65 is communicated with the toner pump 60, and the toner pump 60 is communicated with the developing device 4 via the sub hopper 68. In this manner, the toner bottle 120 is set in the copying machine main body and thereby communicated with the developing device 4.

The toner pump 60 is called “suction type uniaxial eccentric screw pump,” and has two main components: the rotor 61 and the stator 69. The rotor 61 is obtained by forming hard axis-like member with circular cross-sectional shape into a spirally twisted shape, and is connected to a drive motor 66 via a universal joint 64. The stator 69 is made of a rubber-like elastic material and has a hole, an oval cross section of which is in a spirally twisted shape. A spiral pitch of the stator 69 is formed to have a length twice as long as a spiral pitch of the rotor 61. These two components are fitted to each other, and the premixed toner that has entered a space formed between the rotor 61 and the stator 69 can be transported by rotating the rotor 61.

Note that the drive motor 66 and the universal joint 64 are directly connected to each other as shown in the explanatory drawing of FIG. 6. To explain transmission of the driving force with reference to the perspective view of FIG. 5, the driving force of the drive motor 66 is transmitted to the universal joint 64 via a drive shaft 66b and a drive shaft gear 66a.

In the toner pump 60 configured as described above, when the rotor 61 is rotary driven the premixed toner within the toner bottle 120 enters the toner pump 60 from a toner suction port 63. Then, the premixed toner is suctioned and conveyed from the left to the right in FIG. 6, and is thereafter supplied from a toner ejection port 67 to the developing device 4 which is disposed below, through the sub hopper 68 and the toner replenishing port 95 of the developing device 4.

FIG. 7 shows the toner bottle 120.

In FIG. 7, the toner containing body 121 that contains the premixed toner Tp of the toner bottle 120 is formed into a pouch-like shape by welding sheet-like resins called “soft packing material.” As the sheet-like resins configuring the toner containing body 121, a single film obtained by stacking a plurality of resin films made of different materials is used. Specifically, the pouch-like containing body is configured by, in the order from the inner layer thereof, three layers: a weldable layer made of a material that is easily welded; an airtight layer made of a material excellent in airtightness; and a rigid layer made of a material excellent in rigidity.

As the weldable layer, a material that is dissolved at relatively low temperature, such as polyethylene, is used. As the airtight material and the rigid material, PET, nylon, aluminum, paper or the like is used according to the type of the content (solid substance, liquid body, powder body or the like) and the purpose of use of the content (food, medical supply, etc.).

Note that in the toner bottle 120 used in the main copying machine, the toner containing body 121 is configured by a combination of three materials, i.e., polyethylene, nylon and PET, in the order of the inner to the outer side of the toner containing body 121.

Here, each of the layers of the toner containing body 121 is described in detail.

As the weldable layer that is disposed on the inner side of the toner containing body 121 formed into a pouch shape, a material that is dissolved at relatively low temperature is used. Accordingly, the entire material is dissolved when heat is applied thereto so that the sheet-like members can be laminated to each other without forming spaces therebetween.

Furthermore, if the premixed toner Tp is exposed to the air while keeping it, the premixed toner Tp might be degraded. Especially in a high-humidity environment, the premixed toner Tp aggregates, causing a failure in toner replenishment. In order to prevent the occurrence of the failure, the airtight layer is provided in the sheet-like members configuring the pouch member to improve airtightness of the toner bottle 120.

In addition, since a user directly touches the toner bottle 120, easiness of carrying it needs to be considered. By using a material with relatively high rigidity in the sheet-like members configuring the pouch member, and by changing the thickness of this material, rigidity of the toner bottle 120 can be adjusted, whereby a desired rigidity can be provided in the toner bottle 120.

It should be noted that a layer other than these three layers may be further provided.

In the toner containing body 121, the sheet-like members are folded and welded such that the weldable layer and the like face one another. This step is repeated to form a pouch. As an example of the toner containing body 121 in which layers are not welded, there is the one obtained by laminating sheet-like members using an adhesive (e.g.: a pouch member in the form of a paper bag). In this case, the container is folded to form rigid lines, and thus the strength of each rigid line is equal to the strength of the other parts.

On the other hand, in the toner containing body 121, the rigid lines thereof have fusing margins 123. At each of the fusing margins 123, two sheets are welded to each other so the thickness of the sheets is twice as thick as the other parts. Therefore, since each rigid line of the container serves as “column,” the rigidity of the entire container is improved. Accordingly, it is possible to prevent the container from buckling when the container is shaken during conveyance thereof or when a shock is applied when the container is dropped. It is also possible to prevent the toner bottle 120 from being clogged when the surface of the container is deformed in the vicinity of the toner discharge port 122 during replenishment of the premixed toner Tp.

As described above, since the toner containing body 121 is formed from the sheets, it can be deformed according to the shape or volume of the content, and thus the toner bottle 120 can be rolled up into a small size and recycled after use, for example.

Because it is difficult to fix the deformable toner containing body 121 in the toner replenishing device 500, the toner containing body 121 is attached to the base member 130 made of a hard resin or the like, so that the base member 130 and the toner replenishing device 500 are engaged with each other, whereby the toner bottle 120 can be securely installed in the toner replenishing device 500.

The base member 130, which is smaller than the toner containing body 121, is configured from a molding resin with rigidity. By forming the inner layer of the toner containing body 121 and the material of the base member 130 using polyethylene, they can be attached to each other by welding, without forming a space therebetween. Specifically, by inserting a part of the base member 130 into the toner containing body 121 and applying load thereto using a heated welding iron, the base member 130 and the toner containing body 121 can be welded to each other.

As will be described in detail hereinafter, the powder filling method of the present invention is effectively used in a toner containing body that does not require therein a screw or other stirring member, a conveying member and the like, as with the toner containing body 121.

In the toner bottle 120 configured by such a soft toner containing body 121 and the base member 130, the shape of an attachment member 136, which serves as an engaging portion to be engaged with the main body side of the base member 130, differs according to the color of the toner bottle 120. Therefore, the attachment portion can be prevented from being installed in a wrong color of toner bottle 120. Furthermore, an RF tag 124 serving as an information recording member is provided on a side face of the base member 130. Here, the RF tag 124 is an information medium used for reading and writing data of a built-in memory in a non-contact manner by means of electric waves (electromagnetic waves). In this RF tag 124, information items such as the model of the image forming apparatus matching the premixed toner contained in the corresponding toner bottle 120 and the container, the color of the toner, the date manufactured, toner residual amount and the like are recorded.

Next, the replacement of the developer in the developing device 4 will be described.

As described above, the toner replenishing device 500 serving as the developer replenishing device replenishes the premixed toner having a toner and a carrier, which is contained in the toner bottle 120 serving as the powder container, from the toner replenishing port 95 to the developing device 4.

Also, the developing device 4 has a developer discharge port 94, which is developer discharging means for discharging some of the developer within the supply conveyance path 9 to the outside of the developing device 4 when the developer exceeds a predetermined bulk, and a discharge conveyance path 2 that conveys the developer discharged from the developer discharge port 94, to the outside of the developing device 4. The discharge conveyance path 2 is disposed on the downstream side in the conveyance direction of the supply conveyance path 9 such as to be adjacent to the supply conveyance path 9 with a partition wall 135 therebetween. The developer discharge port 94 is an opening provided on the partition wall 135 such that the supply conveyance path 9 and the discharge conveyance path 2 are communicated with each other.

In the developing device 4, the developer accumulates in the vicinity of the downstream end in the conveyance direction of the supply conveyance path 9 in accordance with the balance of the amount of developer conveyed by the supply conveyance path 9, the amount of developer supplied to the developing roller 5, and the amount of developer moving from the supply conveyance path 9 to the stirring/conveyance path 10 via the surplus opening portion 92. When the amount of developer within the developing device 4 is constant, the amount of developer that reaches the vicinity of the downstream end in the conveyance direction of the supply conveyance path 9 per hour matches the amount of developer that moves to the stirring/conveyance path 10 via the surplus opening portion 92 per hour, and the bulk of the developer to be accumulated becomes constant. On the other hand, if the amount of developer within the developing device 4 increases, the amount of developer that reaches the vicinity of the downstream end in the conveyance direction of the supply conveyance path 9 per hour exceeds the amount of developer that moves to the stirring/conveyance path 10 via the surplus opening portion 92 per hour. Consequently, the bulk of the developer accumulating in the vicinity of the downstream end in the conveyance direction of the supply conveyance path 9 increases.

The developer discharge port 94 is disposed in a position where the developer located in the vicinity of the downstream end in the conveyance direction of the supply conveyance path 9 accumulates. When the bulk of the developer to be accumulated increases, the developer that has reached the height of the developer discharge port 94 is discharged to the discharge conveyance path 2 by the developer discharge port 94.

In such a developing device 4, if the premixed toner is not supplied from the toner replenishing device 500, the amount of developer within the developing device 4 hardly changes, and the bulk of the developer accumulated in the vicinity of the downstream end in the conveyance direction of the supply conveyance path 9 also hardly fluctuates. On the other hand, if the premixed toner is replenished from the toner replenishing device 500 to the developing device 4, the amount of developer within the developing device 4 increases, and thereby the bulk of the developer accumulated in the vicinity of the downstream end in the conveyance direction of the supply conveyance path 9 increases. Then, when the bulk of the developer in the vicinity of the downstream end in the conveyance direction of the supply conveyance path 9 increases to reach the height of the developer discharge port 94, the developer that has reached the height of the developer discharge port 94 is discharged to the discharge conveyance path 2 and then discharged to the outside of the developing device 4 via the discharge conveyance path 2.

The developer that is discharged from the developer discharge port 94 to the outside of the developing device 4 via the discharge conveyance path 2 contains a toner and a carrier, while the premixed toner contains unused toner and carrier. Therefore, by replenishing the premixed toner from the toner replenishing device 500 and discharging the developer from the developer discharge port 94, replacement of the developer in the developing device 4 can be performed.

As a conventional image forming apparatus that has a two-component developing device using a developer comprising a toner and a carrier, there is an image forming apparatus in which only the toner is replenished from the toner replenishing device to a developing device. In such an image forming apparatus, the developer within the developing device is degraded with continuous use, causing image deterioration and toner scattering. Therefore, in the image forming apparatus in which only the toner is replenished to the developing device, a service man has to perform a maintenance work to replace the developer regularly.

On the other hand, in the copying machine of the present embodiment, the premixed toner comprising a toner and a carrier is replenished to the developing device 4 to thereby replace the developer in the developing device 4 during image creation so that the life of the developer can be prolonged. Accordingly, the time interval for performing a maintenance can be increased and the downtime can be reduced.

In the toner replenishing device 500 of the present embodiment, the premixed toner Tp comprising a toner and a carrier in the toner bottle 120 serving as the powder container is suctioned by negative pressure of the toner pump 60 serving as the powder pump, and this premixed toner is conveyed through the toner replenishing tube 65 and supplied to the developing device 4. After the inventors of the present invention carried out an experiment for conveying the premixed toner using the toner pump 60, sometimes the toner pump 60 was unable to convey the premixed toner. When only the toner was conveyed or a mixture of the toner and the carrier was conveyed, conveyance could be performed using the toner pump 60 without any problems. However, when only the carrier was conveyed, the toner replenishing tube 65 and the like was clogged by the carrier, and the carrier could not move even when the negative pressure was applied, and thus conveyance could not be performed using the toner pump 60.

If the toner pump 60 is unable to convey the premixed toner due to the carrier clogging up the toner replenishing tube 65 and the like, part replacement, repair operation or other maintenance operation needs to be performed by a service man. Therefore, the image forming apparatus cannot be used until the repair operation is completed, causing downtime.

If a region having the carrier only is generated in the toner bottle 120, only the carrier is conveyed, which disables the toner pump 60 to perform conveyance. The region having the carrier only, which exists in the toner bottle 120, is generated when filling the toner bottle 120 with the premixed toner. When filling the premixed toner into the toner bottle 120, a predetermined amount of toner is supplied from the device containing a toner to be filled, and a predetermined amount of carrier is supplied from the device containing a carrier to be filled, so that the toner and the carrier each are obtained in a predetermined ratio. Because the toner and the carrier are filled into the toner bottle in this manner, after the toner and the carrier are filled therein the region having the carrier only is generated in the toner bottle 120 depending on the filling method used.

Even if the region having the carrier only is generated when filling the premixed toner into the toner bottle 120 in the above manner, the region having the carrier only can be eliminated by shaking the toner bottle 120. The toner and the carrier are stirred and mixed by shaking the toner bottle 120. Air enters between a toner particle and a carrier particle by the shaking operation performed when mixing the toner and the carrier, and then carrier particles with high specific gravity easily move below toner particles having low specific gravity while the air is released. Therefore, after shaking the toner bottle 120, the carrier exists on the lower side of the toner bottle 120 when shaking is stopped, and the toner exists on the upper side of the toner bottle 120 when shaking is stopped. Even when the toner and the carrier exist on either side in the toner bottle 120, the carrier particles and the toner particles contact with each other when the toner bottle 120 is shaken, and thus, in the region having the carrier particles only, the peripheries of the carrier particles are covered by the toner particles. Therefore, the toner can exist in the region having the carrier only, whereby the region having the carrier only can be eliminated. By eliminating the region having the carrier only, the toner pump 60 can be prevented from failing to convey the premixed toner, which is caused by suctioning the carrier only when the toner pump 60 suctions the premixed toner contained in the toner bottle 120.

Consequently, when replacing the toner bottle 120, the user can shake the toner bottle 120 and then install it in the toner replenishing device 500, whereby the toner pump 60 can be prevented from failing to convey the premixed toner.

However, the user sometimes installs the toner bottle 120 in the toner replenishing device 500 without shaking the toner bottle. Also, in the case of the powder container like the toner bottle 120 that does not have the stirring member within the toner containing body 121, particles existing in the vicinity of the toner discharge port 122 are sequentially discharged and particles existing on the far side sequentially move toward the toner discharge port 122 after the powder container is installed in the toner replenishing device 500, and thus the relative positions of the particles hardly fluctuate. For this reason, if the region having the carrier only exists in the toner bottle 120 installed in the toner replenishing device 500, this region eventually reaches the toner discharge port 122.

Therefore, if the toner bottle 120 in which the region having the carrier only is generated when filling the premixed toner into the toner bottle 120 is installed in the toner replenishing device 500 without shaking the toner bottle 120, the region having the carrier only reaches the toner discharge port 122, and then only the carrier is suctioned and conveyed by the toner pump 60, disabling the toner pump 60 to perform conveyance.

In order to cope with such a problem, considered is a method of previously mixing the toner and the carrier in a predetermined proportion to obtain a developer having a mixture of the toner and the carrier, and then filling a plurality of toner bottles with premixed toner which is the developer. Prior Art 2 described above discloses a method of using a screw to fill the powder container with a developer obtained by mixing a toner and a carrier using a mixer or the like. In this method, if the toner and the carrier are not mixed uniformly, the ratio between the toner and the carrier in the premixed toner fluctuates among the powder containers, depending on the order of filling.

In the present embodiment, in the configuration of replenishing the premixed toner from the powder container containing the toner and the carrier in a predetermined proportion to the developing device and replacing the carrier while replenishing the consumed toner, the ratio of the toner and the ratio of the carrier in the powder container are previously determined so as to keep a balance between the toner ratio and the carrier ratio in the developer contained in the developing device when replenishment of the developer in a single powder container is finished. If an individual difference in the toner ratio and the carrier ratio of the developer contained in a single powder container is generated among the powder containers, the balance between the toner ratio and the carrier ratio in the developing device might be lowered upon completion of replenishment of the premixed toner in a single powder container. If the balance between the toner ratio and the carrier ratio is lowered, uniformity and gradation properties of an image might be deteriorated, and thereby image quality is lowered, or the apparatus might be polluted due to toner scattering. For example, if the carrier ratio in the premixed toner contained by a single powder container is too low, deterioration of the developer might be accelerated, but if the carrier ratio is too high, the toner yield might be reduced.

Because there is a difference in specific gravity between the carrier and the toner, even if the developer is stirred, the carrier easily accumulates at the bottom of the developer within the container containing the stirred developer, and thus it is difficult to mix the toner and the carrier uniformly. Moreover, if the developer is stirred a number of times or for a long period of time in order to mix the toner and the carrier uniformly, the toner and the carrier might be deteriorated.

Next is described a filling device that fills the toner bottle 120 serving as the powder container of the present embodiment with the toner and the carrier.

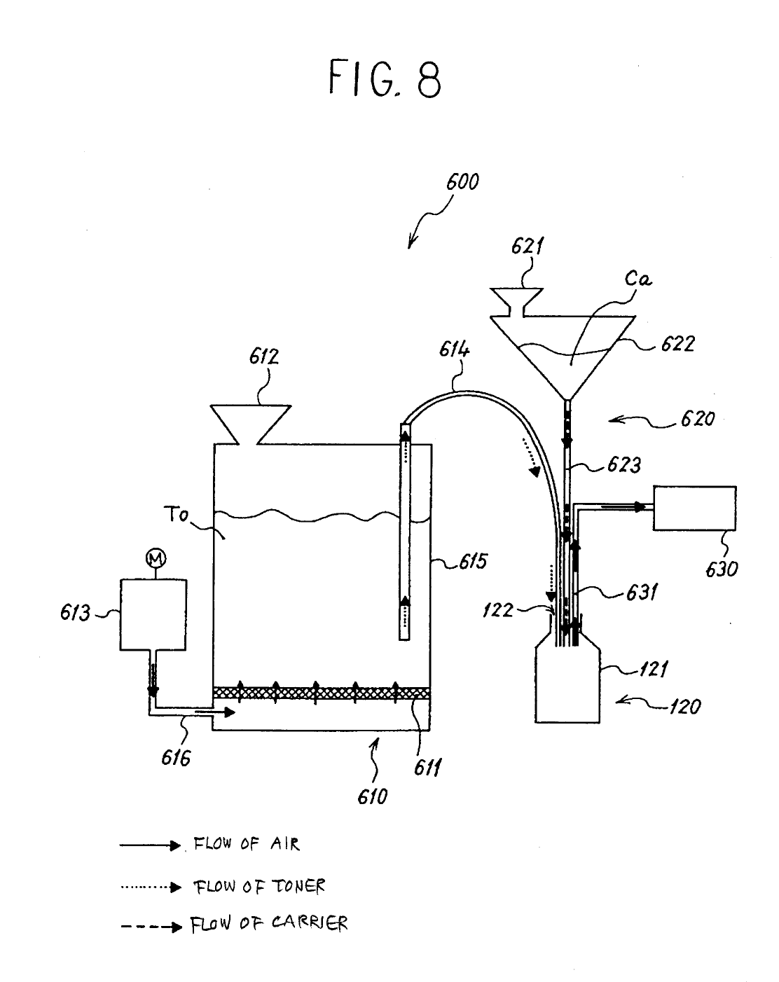

FIG. 8 shows a configuration of a powder filling device 600 that fills the toner bottle 120 of the present embodiment with the premixed toner comprising the toner and the carrier.

As shown in FIG. 8, the powder filling device 600 has a toner filling device 610 for filling the toner bottle 120 with the toner, and a carrier filling device 620 for filling the toner bottle 120 with the carrier. The powder filling device 600 also has a degasifier 630 for releasing the air from the toner bottle 120 after the toner and the carrier are filled therein. When the premixed toner, which is the developer, is filled into the toner bottle 120, the toner discharge port 122 is turned upward, and the toner and the carrier are filled into the toner bottle 120 through the toner discharge port 122, as shown in FIG. 8.

The toner filling device 610 has a toner storage portion 615 for storing a toner To supplied from a toner supply port 612, and an air supply device 613 for supplying air to the toner within the toner storage portion 615. A toner filling nozzle 614 that conveys the toner To within the toner storage portion 615 by means of the suction of force of a powder pump, not shown, is connected to the toner storage portion 615. Moreover, an gas-powder separation screen 611 that has an opening through which the air can pass but the toner cannot pass is disposed below the toner storage portion 615. An air supply nozzle 616 that is connected to the air supply device 613 is connected to the space below the toner storage portion 615 partitioned by the gas-powder separation screen 611. The end portion of the toner filling nozzle 614 to which the toner storage portion 615 is not connected is inserted into the toner discharge port 122 serving as the powder discharge port of the toner bottle 120, and then the unshown powder pump is driven, whereby the toner To can be filled into the toner bottle 120. The amount of toner To to be filled is adjusted according to the time period during which the unshown powder pump is driven.

On the other hand, the carrier filling device 620 has a carrier storage portion 622 for storing a carrier Ca supplied from a carrier supply port 621. A carrier filling nozzle 623 is connected to the lowermost part of the carrier storage portion 622, and the connecting part between the carrier storage portion 622 and the carrier filling nozzle 623 is provided with an on-off valve, which is not shown. The end portion of the carrier filling nozzle 623 to which the carrier storage portion 622 is not connected is inserted into the toner discharge port 122 of the toner bottle 120, and then the unshown on-off valve is opened, whereby the carrier Ca can be filled into the toner bottle 120. The carrier Ca is moved from the carrier storage portion 622 to the toner bottle 120 by gravity, and the amount of carrier Ca to be filled is adjusted according to the time period during which the unshown on-off valve is opened.

In addition, an end of a degasifying nozzle 631 is connected to the degasifier 630, and the other end is inserted into the toner discharge port 122 of the toner bottle 120 to drive the degasifier 630, whereby the air inside the toner bottle 120 can be released.

### EXAMPLE 1

Next is described the first example (called “Example 1” hereinafter) of the powder filling method of the present invention in which the powder filling device 600 shown in FIG. 8 is used to fill the toner bottle 120 serving as the powder container with the toner and the carrier.

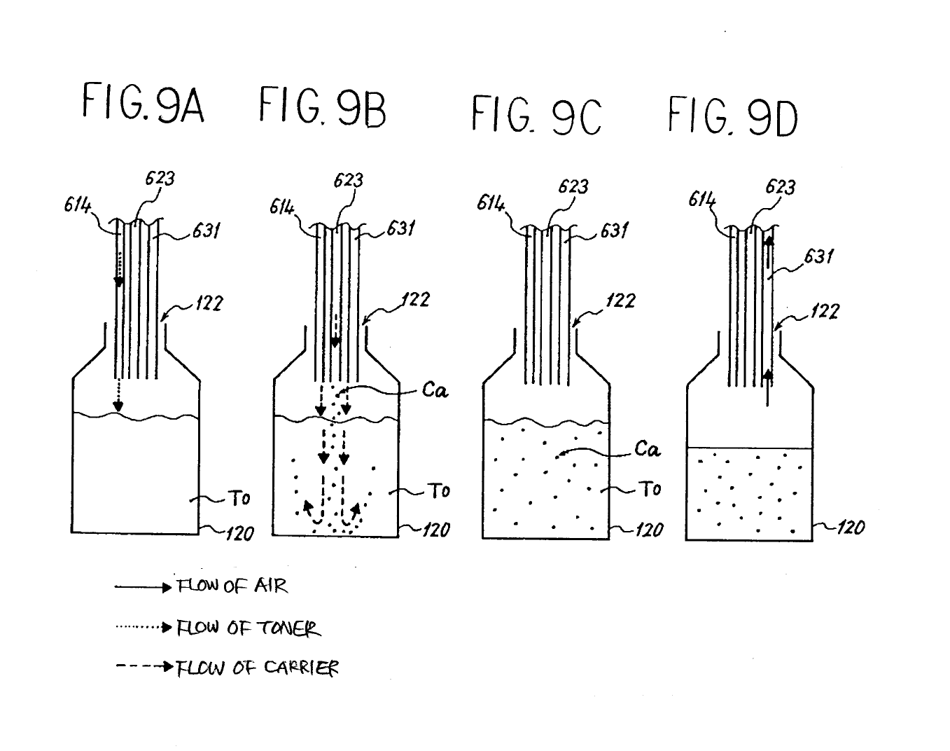

The powder filling method of Example 1 is described with reference to FIGS. 9A through 9D.

The powder filling method of Example 1 is carried out according to the following procedures (1) through (4).

(1) The air supply device 613 is used to send air into the toner To contained in the toner storage portion 615 of the toner filling device 610 shown in FIG. 8, and the air is introduced into particles of the toner To to increase the bulk of the toner To, so that high toner fluidity is obtained.

(2) As shown in FIG. 9A, the toner To having the air is filled from the toner filling nozzle 614 into the toner bottle 120.

(3) As shown in FIG. 9B, upon completion of filling of the toner To, the carrier filling device 620 is used to fill the carrier Ca contained in the carrier storage portion 622, from the carrier filling nozzle 623 into the toner bottle 120.

(4) Upon completion of filling of the carrier Ca as shown in FIG. 9C, the degasifier 630 is used to remove excess air within the toner bottle 120 from the degasifying nozzle 631, as shown in FIG. 9D.

In the procedure (3), the air is released from the particles of the toner To contained in the toner bottle 120 that is filled first, whereby the bulk of the toner To is reduced, and then the carrier Ca is filled into the toner bottle 120 before the bulk of the toner To becomes stable. By filling the toner bottle 120 with the carrier Ca while the fluidity of the toner To is high when the air is contained in the toner particles, the carrier Ca with higher specific gravity than the toner To sinks into the toner To so that particles of the carrier Ca can be introduced into the particles of the toner To. The particles of the carrier Ca that were introduced into the toner To having high fluidity can be easily moved within the toner To. Therefore, as shown in FIG. 9B, the carrier Ca sinks into the toner To due to the difference in specific gravity between the toner To and the carrier Ca, causing convection in the developer, whereby the toner and the carrier are mixed. Because the convection allows the toner and the carrier to be mixed, the carrier Ca is dispersed in the toner To, as shown in FIG. 9C.

As shown in FIG. 9C, according to the procedure (4), excess air is removed in the state in which the carrier Ca is dispersed in the toner To, and the air contained between the particles of the toner To is removed. When the air contained between the particles of the toner To is removed, the bulk of the developer having the toner To and the carrier Ca is reduced, as shown in FIG. 9D, and the particles of the toner To and of the carrier Ca become dense, whereby the fluidity of the toner To and the carrier Ca is lowered. Since the fluidity is lowered by removing the air when the carrier Ca is dispersed in the toner To, the toner To and the carrier Ca can be kept mixed together.

According to the powder filling method of Example 1, air is mixed with the toner To, which is the first powder that does not contain the carrier Ca with the highest specific gravity, the carrier Ca being contained in the premixed toner comprising two kinds of powders with different specific gravities, whereby the fluidity of the toner To can be improved. Moreover, after the toner To is filled into the toner bottle 120 serving as the powder container, the carrier Ca with the highest specific gravity, which is the second powder of the two kinds of the powders, is filled into the toner bottle. Accordingly, a region having the carrier Ca only is prevented from being generated on the lower part of the toner bottle 120 with respect to a region having the toner To. Then, when the bulk of the toner To is reduced by removing the air from the particles of the toner To that is filled in the toner bottle 120 first, and before the bulk of the toner To becomes stable, that is, when the fluidity of the toner To is still high, filling of the carrier Ca is completed. Consequently, the carrier Ca with the higher specific gravity than the toner To can be introduced into the particles of the toner To such that the carrier Ca sinks into the toner. Therefore, a region having the carrier Ca only is prevented from being generated on the toner discharge port 122 side, with respect to the region having the toner To, the toner discharge port 122 being the opening portion for supplying the powders to the toner bottle 120. In addition, because the carrier Ca is introduced into the particles of the toner To, most of the particles of the carrier Ca are prevented from gathering, and, for the carrier Ca in the toner To, a region having the carrier Ca only is prevented from being generated.

### EXAMPLE 2

Next is described the second example (called “Example 2” hereinafter) of the powder filling method of the present invention in which the powder filling device 600 shown in FIG. 8 is used to fill the toner bottle 120 serving as the powder container with the toner and the carrier.

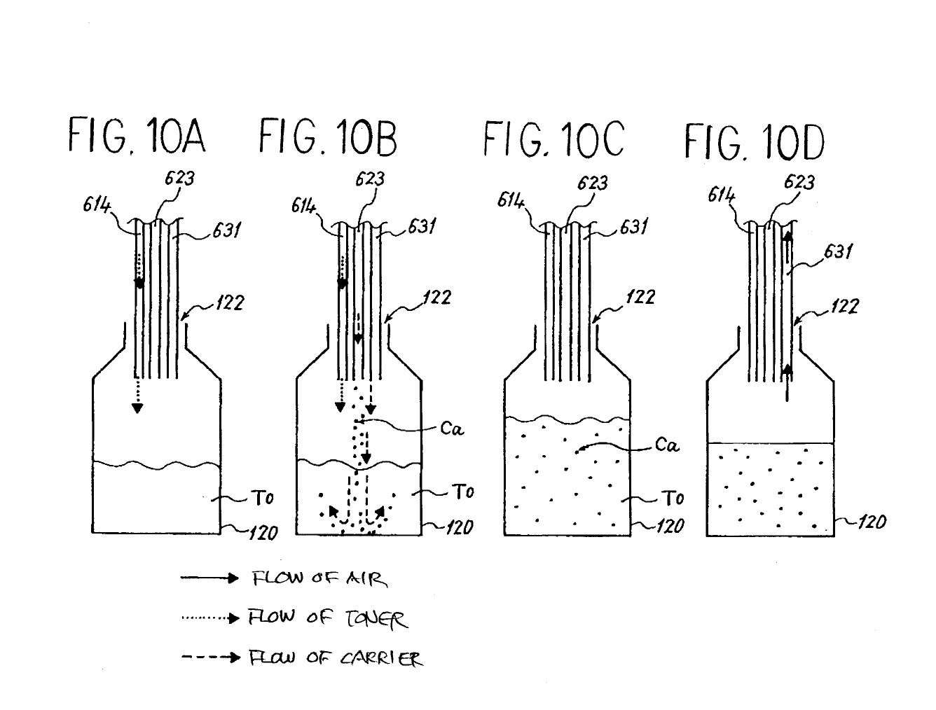

The powder filling method of Example 2 is described with reference to FIGS. 10A through 10D.

The powder filling method of Example 2 is carried out according to the following procedures (1) through (4).

(1) The air supply device 613 is used to send air into the toner To contained in the toner storage portion 615 of the toner filling device 610 shown in FIG. 8, and the air is introduced into particles of the toner To to increase the bulk of the toner To, so that high toner fluidity is obtained.

(2) As shown in FIG. 10A, the toner To having the air is filled from the toner filling nozzle 614 into the toner bottle 120.

(3) As shown in FIG. 10B, during the process of filling the toner To, the carrier filling device 620 is used to fill the carrier Ca contained in the carrier storage portion 622, from the carrier filling nozzle 623 into the toner bottle 120.

(4) Upon completion of filling of the carrier Ca and toner To as shown in FIG. 10C, the degasifier 630 is used to remove excess air within the toner bottle 120 from the degasifying nozzle 631, as shown in FIG. 10D.

The timing for starting to fill the toner bottle with the carrier Ca in the powder filling method of Example 2 is different from that of the powder filling method of Example 1. In Example 1, filling of the carrier Ca is started upon completion of filling of the toner To, but in Example 2 the filling of the toner To is started first and then filling of the carrier Ca is started during the process of filling the toner To. By filling the carrier Ca and the toner To together, filling of the carrier Ca can be performed while the fluidity of the toner To is higher than that obtained in Example 1. Therefore, unlike Example 1, convection occurs more easily when filling the carrier Ca into the toner bottle, whereby the toner To and the carrier Ca can be mixed easily.

By mixing the toner To and the carrier Ca together, the carrier Ca is dispersed in the toner To, as shown in FIG. 10C.

As shown in FIG. 10C, according to the procedure (4), excess air is removed in the state in which the carrier Ca is dispersed in the toner To, and the air contained between the particles of the toner To is removed. When the air contained between the particles of the toner To is removed, the bulk of the developer having the toner To and the carrier Ca is reduced, as shown in FIG. 10D, and the particles of the toner To and of the carrier Ca become dense, whereby the fluidity of the toner To and the carrier Ca is lowered. Since the fluidity is lowered by removing the air when the carrier Ca is dispersed in the toner To, the toner To and the carrier Ca can be kept mixed together.

According to the powder filling method of Example 2, air is mixed with the toner To, which is the first powder, the fluidity of the toner To can be improved, as with Example 1. Moreover, after starting to fill the toner To into the toner bottle 120, filling of the carrier Ca, i.e., the second powder, is started. Accordingly, a region having the carrier Ca only is prevented from being generated on the lower side of the toner bottle 120 with respect to a region having the toner To. Then, in Example 2, filling of the carrier Ca is started during the process of filling the toner To, the carrier Ca can be filled into the bottle when the fluidity of the toner To is still high. Consequently, the carrier Ca with the higher specific gravity than the toner To can be introduced into the particles of the toner To such that the carrier Ca sinks into the toner. Therefore, a region having the carrier Ca only is prevented from being generated on the toner discharge port 122 side, with respect to the region having the toner To, the toner discharge port 122 being the opening portion for supplying the powders to the toner bottle 120. In addition, because the carrier Ca is introduced into the particles of the toner To, most of the particles of the carrier Ca are prevented from gathering, and, for the carrier Ca in the toner To, a region having the carrier Ca only is prevented from being generated.

As described above, by using the powder filling method of Example 1 or Example 2 to fill the toner bottle 120 with the toner To and the carrier Ca, a region having the carrier Ca only can be prevented from being generated in the filled toner bottle 120.

The region having the carrier Ca only is not generated in the toner bottle 120, which is a filled powder container filled with the premixed toner by the powder filling method of Example 1 or Example 2. Therefore, the toner To is discharged along with the carrier Ca from the toner discharge port 122.

By installing the toner bottle 120, which is filled with the premixed toner by the powder filling method of Example 1 or Example 2, in the toner replenishing device 500 serving as the developer replenishing device for conveying the premixed toner or developer by means of the negative pressure generated by the toner pump 60 serving as the powder pump, the carrier Ca is prevented from being conveyed alone. Accordingly, the toner pump 60 can be prevented from being disabled to convey the premixed toner, whereby the premixed toner can be replenished to the developing device 4 in a stable manner.

In the copying machine, which serves as the image forming apparatus having the toner bottle 120 installed in the toner replenishing device 500, the toner bottle 120 being filled with the premixed toner by the powder filling method of Example 1 or Example 2, a stable image formation can be performed because the premixed toner is replenished to the developing device 4 in a stable manner.

In addition, according to the powder filling method of Example 1 or Example 2, the toner To and the carrier Ca are mixed together in a state in which the toner particles are separated from the carrier particles, and thus the particles hardly collide or come into contact with each other so that stress is not added to the toner To and the carrier Ca. Therefore, in the premixed toner that is filled into the toner bottle 120 by the powder filling method of Example 1 or Example 2, the toner To and the carrier Ca are hardly degraded before they are filled into the toner bottle 120. Therefore, in the copying machine of the present embodiment, the premixed toner can be prevented from being degraded before it is supplied to the developing device 4, hence high-quality image formation can be realized.

The toner bottle 120 serving as the powder container of the present embodiment is a powder container having a stirring member therein. As the powder container that is filled with the toner and the carrier by the powder filling method of Example 1 or Example 2, the one having therein a paddle or a stirring member may be used. As long as the powder container has a stirring member therein, the developer is stirred by the stirring member even if the container filled with the toner and the carrier has a region with the carrier only, hence such a problem that only the carrier is discharged is hardly caused. On the other hand, by using the powder filling methods of Example 1 and Example 2, stress is not added to the toner and the carrier before the powder container is filled with the toner and the carrier. Therefore, by using the powder container that is filled with the premixed toner by the powder filling method of Example 1 or Example 2, the premixed toner can be prevented from being degraded before it is supplied to the developing device, hence high-quality image formation can be realized.

Moreover, according to the powder container having the stirring member therein, even if the powder container is not filled with completely uniform toner and carrier, the powder container can be installed in the image forming apparatus to mix and uniformly disperse the toner and the carrier even during the process of replenishing the developer contained in the developing device. Note that the powder container that is installed in the image forming apparatus and then rotates to replenish toner to the developing device is the same as the one having the stirring member.

The present embodiment has described the toner bottle 120, which serves the powder container containing two or more kinds of powders with different specific gravities and also serves as the developer container containing a toner and a carrier and installed in a copying machine serving as an image forming apparatus.

As the characterizing portion of the present invention, the powder container, which is filled with at least two kinds of powders with different specific gravities by using the powder filling method described in Example 1 and Example 2, is not limited to the developer container. By using the powder filling method of Example 1 or Example 2 to fill the powder container with at least two kinds of powders with different specific gravities, a region that has only the powder with the highest specific gravity is prevented from being generated in the powder container.

According to the present embodiment described above, the fluidity of the toner To can be improved by mixing air with the toner To serving as the first powder that does not have the powder with the highest specific gravity, and then by increasing the bulk of the toner by introducing the air into the particles. Further, particles of the carrier Ca serving as the second powder can be introduced to particles of the toner To when the carrier Ca is supplied. Moreover, by starting to fill the toner bottle 120 serving as the powder container with the carrier Ca after filling of the toner To is started, a region having the carrier Ca only is prevented from being generated on the lower side (far side) of the carrier bottle 120, with respect to a region having the toner To. Then, when the bulk of the toner To is reduced by removing the air from the particles of the toner To that is filled in the toner bottle 120, and before the bulk of the toner To becomes stable, that is, when the fluidity of the toner To is still high, filling of the carrier Ca is completed. Consequently, the carrier Ca with higher specific gravity than the toner To can be introduced into the particles of the toner To. Therefore, a region having the carrier Ca only is prevented from being generated above the region having the toner, that is, on the toner discharge port 122 side serving as the opening portion for supplying the powders to the toner bottle 120. In addition, because the carrier Ca is introduced into the particles of the toner To, most of the particles of the carrier Ca are prevented from gathering, and, for the carrier Ca in the toner To, a region having the carrier Ca only is prevented from being generated.

Also, as in Example 1, according to the powder filling method in which filling of the carrier Ca is started after filling of the toner To into the toner bottle 120 is completed, filling of the carrier Ca is completed when the fluidity of the toner To is high, whereby the toner To and the carrier Ca can be mixed together and the region having the carrier Ca only can be prevented from being generated in the toner bottle 120.

Furthermore, as in the powder filling method of Example 2, by starting to fill the carrier Ca into the toner bottle 120 during the process of filling the toner To into the same, the carrier Ca can be filled into the bottle while the fluidity of the toner To is higher than that obtained in Example 1. Consequently, the toner To and the carrier Ca can be mixed easily.

In the premixed toner serving as a developer comprising two or more powders such as a toner and a carrier, the first powder that does not contain a powder with the highest specific gravity and comprises one or more powders is taken as the toner, and the second powder that has the powder with the highest specific gravity out of the two or more powders is taken as the carrier, and thus the powder filling method of the present invention can be applied when filling the developer in the powder container.

The region having the carrier Ca only can be prevented from being generated in the toner bottle 120, which is the powder container that is filled with the premixed toner by the powder filling method of Example 1 or Example 2.

As the developer container of the toner replenishing device 500 serving as the developer replenishing device, the toner bottle 120 that is filled with the premixed toner by the powder filling method of Example 1 or Example 2 is used so that the powder conveyed by the toner replenishing device 500 can be prevented from being obtained as only the carrier.

The toner pump 60 serving as the powder pump is provided as the developer conveying means of the toner replenishing device 500, and the developer is conveyed by the negative pressure of the toner pump 60, whereby the degree of freedom of the layout of the toner bottle 120 and developing device 4 can be increased. Here, when trying to convey the carrier only by means of the toner pump 60, the conveyance path member might be clogged by the carrier, disabling the conveyance path member to perform conveyance. However, the toner replenishing device 500 of the present embodiment can prevent conveyance of the carrier only, hence the toner pump 60 can be prevented from being disabled to convey the premixed toner. Therefore, the premixed toner can be replenished in a stable manner.

Furthermore, when replenishing the premixed toner from the developer container to the developing device 4, the premixed toner is discharged from the toner bottle 120 serving as the developer container or powder container that is filled with the premixed toner by the powder filling method of Example 1 or Example 2, and is then replenished to the developing device 4. Accordingly, the carrier is prevented from being supplied alone to the developing device 4.

Moreover, because the copying machine serving as the image forming apparatus uses the toner replenishing device 500 serving as the developer replenishing means, the premixed toner can be replenished in a stable manner, and thus stable image formation can be realized.

In addition, since the copying machine has the developer discharge port 94 that serves as the developer discharging means for discharging the developer from the supply conveyance path 9 configuring the developer containing portion of the developing device 4, the developer that is increased by replenishing the premixed toner from the toner bottle 120 can be discharged from the developer discharge port 94. Accordingly, the developer within the developing device 4 can be replaced and the life of the developer can be prolonged.

Regarding the method for manufacturing the toner bottle 120 serving as the powder-filled powder container, the powder filling method of Example 1 or Example 2 is used, and thus the region with the carrier only is prevented from being generated in the manufactured toner bottle 120.

As described above, according to the present invention, a region that has only the second powder having a powder with the highest specific gravity and a region having the first powder are prevented from being generated above and below the powder container, with respect to the first powder within the powder container filled with the powders. Therefore, the present invention has the excellent effect that the region having only the powder with the highest specific gravity is prevented from being generated in the powder container filled with the powders.

Various modifications will become possible for those skilled in the art after receiving the teachings of the present disclosure, without departing from the scope thereof.

What is claimed is:

1. A powder filling method for filling at least two kinds of powders with different specific gravities into a powder container, the method comprising the steps of:
mixing air with a first powder of the at least two kinds of powders, which comprises at least one powder that does not include a powder with the highest specific gravity, and then introducing the air into particles of the first powder to increase the bulk of the first powder;
starting to fill a second powder of the at least two kinds of powders, which includes a powder with the highest specific gravity, into the powder container after starting to fill the first powder into the powder container; and
completing filling of the second powder before the air is released from the particles of the first powder within the powder container and thereby the bulk of the first powder is reduced and then stabilized.

2. The powder filling method as claimed in claim 1, further comprising the step of starting to fill the second powder into the powder container-upon completion of filling of the first powder into the powder container.

3. The powder filling method as claimed in claim 1, further comprising the step of starting to fill the second powder into the powder container while the first powder is being filled into the powder container.

4. The powder filling method as claimed in claim 1, wherein the at least two kinds of the powders have a toner and a carrier, the first powder has the toner, and the second powder has the carrier.

5. A powder-filled powder container, which is obtained by filling a powder container with at least two kinds of powders with different specific gravities,
wherein the at least two kinds of powders are filled into the powder container by means of a powder filling method having the steps of:
mixing air with a first powder of the at least two kinds of powders, which comprises at least one powder that does not include a powder with the highest specific gravity, and then introducing the air into particles of the first powder to increase the bulk of the first powder;
starting to fill a second powder of the at least two kinds of powders, which includes a powder with the highest specific gravity, into the powder container after starting to fill the first powder into the powder container; and
completing filling of the second powder before the air is released from the particles of the first powder within the powder container and thereby the bulk of the first powder is reduced and then stabilized.

6. A developer replenishing device, comprising:
a developer container that contains a developer comprising a toner and a carrier; and
developer conveying means for conveying the developer to a destination of conveyance,
wherein the developer container is a powder-filled powder container, which is obtained by filling a powder container with at least two kinds of powders with different specific gravities, the at least two kinds of powders being filled into the powder container by means of a powder filling method having the steps of:
mixing air with a first powder of the at least two kinds of powders, which comprises at least one powder that does not include a powder with the highest specific gravity, and then introducing the air into particles of the first powder to increase the bulk of the first powder;
starting to fill a second powder of the at least two kinds of powders, which includes a powder with the highest specific gravity, into the powder container after starting to fill the first powder into the powder container; and
completing filling of the second powder before the air is released from the particles of the first powder within the powder container and thereby the bulk of the first powder is reduced and then stabilized.

7. The developer replenishing device as claimed in claim 6, wherein the developer conveying means has:
a conveyance path member in which the developer travel; and
a powder pump that applies negative pressure to the developer contained in the developer container, and moves the developer to the destination of conveyance of the developer via the conveyance path member.

8. An image forming apparatus, comprising:
a latent image carrier;
a developing device that develops a latent image formed on the latent image carrier using a developer contained in a developer containing portion; and
developer replenishing means for supplying the developer to the developer containing portion,
wherein the developer replenishing means is a developer replenishing device having:
a developer container that contains a developer comprising a toner and a carrier; and
developer conveying means for conveying the developer to a destination of conveyance, and
the developer container is a powder-filled powder container, which is obtained by filling a powder container with at least two kinds of powders with different specific gravities, the at least two kinds of powders being filled into the powder container by means of a powder filling method having the steps of:
mixing air with a first powder of the at least two kinds of powders, which comprises at least one powder that does not include a powder with the highest specific gravity, and then introducing the air into particles of the first powder to increase the bulk of the first powder;
starting to fill a second powder of the at least two kinds of powders, which includes a powder with the highest specific gravity, into the powder container after starting to fill the first powder into the powder container; and
completing filling of the second powder before the air is released from the particles of the first powder within the powder container and thereby the bulk of the first powder is reduced and then stabilized.

9. The image forming apparatus as claimed in claim 8, further comprising developer discharging means for discharging the developer from the developer containing portion.

10. A developer replenishing method for replenishing a developer comprising a toner and a carrier having different specific gravities, from a developer container to a developing device, the method comprising the steps of:
mixing air with the toner and then introducing the air into particles of the toner to increase the bulk of the toner;
starting to fill the carrier into the developer container after starting to fill the toner into the developer container;
completing filling of the carrier before the air is released from the particles of the toner within the developer container and thereby the bulk of the toner is reduced and then stabilized; and
discharging the developer from the developer container filled with the developer comprising the toner and the carrier, to replenish the developer into the developing device.

11. A powder-filled powder container manufacturing method for manufacturing a powder container filled with at least two kinds of powders with different specific gravities, the method comprising the steps of:
mixing air with a first powder of the at least two kinds of powders, which comprises at least one powder that does not include a powder with the highest specific gravity, and then introducing the air into particles of the first powder to increase the bulk of the first powder;
starting to fill a second powder of the at least two kinds of powders, which includes a powder with the highest specific gravity, into the powder container after starting to fill the first powder into the powder container; and
completing filling of the second powder before the air is released from the particles of the first powder within the powder container and thereby the bulk of the first powder is reduced and then stabilized.
